(19) United States
(12) Patent Application Publication
(10) Pub. No.: US 2019/0119794 A1
(43) Pub. Date: Apr. 25, 2019

(54) MACHINING TOOL

(71) Applicant: CERATIZIT AUSTRIA GESELLSCHAFT M.B.H., REUTTE (AT)

(72) Inventors: CHRISTINE TOUFAR, REUTTE (AT); UWE SCHLEINKOFER, REUTTE (AT)

(21) Appl. No.: 16/083,065

(22) PCT Filed: Mar. 9, 2017
(86) PCT No.: PCT/AT2017/000012

§ 371 Date: Sep. 7, 2018

(30) Foreign Application Priority Data
Mar. 11, 2016 (AT) GM 52/2016

(51) Int. Cl. C22C 29/06; B23B 27/16; C22C 29/08; B22F 5/00; B22F 1/00

(52) U.S. Cl. CPC C22C 29/067; B23B 27/1659; C22C 29/08; B22F 5/00; B22F 2304/10; B23B 2222/28; B22F 2005/001; B22F 2301/15; B22F 2302/10; B22F 1/0011

(57) ABSTRACT

A cutting machining tool for metal-containing materials has a base material composed of cemented hard material with hard material particles embedded in a ductile metallic binder. The metallic binder is a Co—Ru alloy and the hard material particles are formed at least predominantly by tungsten carbide, having an average grain size of the tungsten carbide of 0.1-1.2 μm. The cemented hard material has a (Co+Ru) content of 5-17% by weight of the cemented hard material, a Ru content of 6 16% by weight of the (Co+Ru) content, a Cr content of 2-7.5% by weight of the (Co+Ru) content, a content of Ti, Ta and/or Nb of in each case <0.2% by weight of the cemented hard material and a V content of <0.3% by weight of the cemented hard material.

The present invention relates to a cutting machining tool for metal-containing materials and the use of a cemented hard material for a cutting machining tool for metal-containing materials.

Cutting machining tools made of cemented hard material are usually employed for cutting machining of metal-containing materials, in particular metals and metal-containing composite materials. Cemented hard material is a composite material in which hard particles which can in particular be composed of metal carbides and carbonitrides are embedded in a ductile metallic binder. Cemented hard material in which the hard particles are at least predominantly formed by tungsten carbide (WC) and the binder is a cobalt- or nickel-based alloy, in particular a cobalt-based alloy, is most widespread. An alloy based on a metal means that this metal forms the main constituent of the alloy.

As cutting machining tools, use is made of both solid cemented hard material tools in which a cutting region is formed in one piece with the tool shaft of the cemented hard material and also tools having exchangeable cutting inserts made of cemented hard material fastened to a main element of the tool. In the case of the solid cemented hard material tools, various regions can optionally be formed by different cemented hard material types. Furthermore, the cutting machining tools are often also provided with a hard material coating which is deposited on the cemented hard material by means of, for example, a PVD (physical vapor deposition) process or a CVD (chemical vapor deposition) process.

In the field of cutting machining tools having exchangeable cutting inserts, cemented hard material in which the metallic binder is formed by a cobalt-ruthenium alloy (Co—Ru alloy) is sometimes used for the cutting inserts. Apart from cobalt and ruthenium, the Co—Ru alloy can additionally comprise further elements. However, it has been found that these known cemented hard materials do not yet have the combination of a high hot strength, a fine grain size of the tungsten carbide grains and a high fracture toughness which is desired for many cutting machining applications.

It is an object of the present invention to provide an improved cutting machining tool for metal-containing tools and a corresponding improved use of a cemented hard material for a cutting machining tool for metal-containing materials, by means of which, in particular, an improved combination of high hot strength, fine grain size and high fracture toughness are achieved.

The object is achieved by a cutting machining tool for metal-containing materials as claimed in claim 1. Advantageous embodiments are indicated in the dependent claims.

The cutting machining tool has a base material composed of cemented hard material which has hard material particles embedded in a ductile metallic binder. The metallic binder is a Co—Ru alloy. The hard material particles are at least predominantly formed by tungsten carbide having an average grain size of the tungsten carbide of 0.1-1.2 μm. The base material has a (Co+Ru) content of 5-17% by weight of the cemented hard material, an Ru content (ruthenium content) of 6-16% by weight of the (Co+Ru) content, a Cr content (chromium content) of 2-7.5% by weight of the (Co+Ru) content, a content of Ti (titanium), Ta (tantalum) and/or Nb (niobium) of in each case <0.2% by weight of the cemented hard material and a V content (vanadium content) of <0.3% by weight of the cemented hard material, preferably <0.2% by weight. For the present purposes, the (Co+Ru) content is the total content (in % by weight) of cobalt and ruthenium in the cemented hard material, which is given by addition of the Co content (cobalt content) in % by weight and the Ru content (ruthenium content) in % by weight. A high hot strength, in particular, can be achieved using the Ru content in the range indicated. At an Ru content below about 6% by weight of the total binder content (i.e. the (Co+Ru) content), no satisfactory improvement in the hot strength is achieved, while at an excessively high Ru content above about 16% by weight of the (Co+Ru) content, the microstructural properties are adversely affected. In order to suppress undesirable grain growth of the WC grains during sintering reliably and thus obtain a desired uniform small grain size of the tungsten carbide grains, the addition of Cr as grain growth inhibitor in an amount of at least 2% by weight of the (Co+Ru) content is suggested. Since Cr is soluble in the binder up to a certain percentage, the Cr content is appropriately based on the binder content of the cemented hard material, i.e. on the (Co+Ru) content. On the other hand, the Cr content has to be kept sufficiently low below about 7.5% by weight of the (Co+Ru) content in order that the wetting of the tungsten carbide grains by the cobalt is not adversely affected. In order to achieve a high hardness, it can be advantageous to add small amounts of vanadium, in particular in the form of VC (vanadium carbide), but the V content should not exceed about 0.3% by weight of the cemented hard material in order to avoid embrittlement and thus lowering of the fracture toughness. The V content should preferably be less than 0.2% by weight of the cemented hard material. Depending on the desired properties of the resulting cemented hard material, it can also be advantageous to add small amounts of Ti, Ta and/or Nb, with the addition being able, in particular, to be effected in the form of TiC, TaC, NbC or in the form of mixed carbides. However, in order not to endanger the property improvements achieved by means of the indicated Ru content and Cr content, it is important to keep the Ti content, the Ta content and the Nb content in each case at least below 0.2% by weight of the cemented hard material, preferably in each case below 0.15% by weight of the cemented hard material. The cutting machining tool for metal-containing materials can, for example, be configured as a solid cemented hard material tool in which the cutting region provided for cutting machining is formed in one piece with a shaft composed of cemented hard material. However, it is also possible for, for example, regions having different cemented hard material to be used, e.g. the cutting region has a different cemented hard material type than the shaft region. However, the cutting machining tool can, for example, also be configured as an exchangeable cutting insert which is configured for being fastened to an appropriate tool holder. The base material composed of cemented hard material in the cutting machining tool for metal-containing materials can optionally also be provided, in a manner which is known per se, with a hard material coating which can be formed, in particular, by means of a CVD (chemical vapor deposition) process or a PVD (physical vapor deposition) process. The cutting machining tool for metal-containing materials according to the invention provides a particularly advantageous combination of high hot strength, fine grain size and high fracture toughness, which is, in particular, also suitable for cutting machining of materials which are difficult to machine, in particular high-alloy steels, titanium alloys and superalloys. The composition of the base material can, in particular, be determined by elemental analysis by means of XRF (X-ray fluorescence analysis).

In an advantageous embodiment, the cemented hard material additionally has an Mo content in the range 0-3.0% by weight of the cemented hard material. The Mo content (molybdenum content) is preferably in the range from 0.1 to 3.0% by weight of the cemented hard material, particularly preferably from 0.15 to 2.5% by weight of the cemented hard material. It has been found that a targeted addition of molybdenum has a particularly advantageous effect on the properties of the cemented hard material, in particular a particularly advantageous combination of a fine grain size of the WC and a high fracture toughness. The molybdenum can be added, in particular, in the form of Mo₂C (molybdenum carbide), but addition as metallic molybdenum, for example, is also possible. The addition of molybdenum in the amounts indicated has been found to be particularly advantageous. When Mo is added in larger amounts of more than 3.0% by weight, no further improvement in the properties of the cemented hard material is observed. An addition of more than 2.5% by weight of the cemented hard material is also disadvantageous for cost reasons.

In one embodiment, the average grain size of the tungsten carbide is 0.15 μm-0.9 μm. It has been found that, in particular, an advantageous combination of hardness, fracture toughness and hot strength, which allows not only use in exchangeable cutting inserts but also use as solid cemented hard material tool, is obtained at such grain sizes in combination with the indicated composition of the cemented hard material.

The Cr content is preferably less than the Ru content. In particular, the Cr content is preferably less than half the Ru content. In this case, the desired increase in the hot strength firstly is reliably attained and a relatively small average grain size of the tungsten carbide grains is achieved, but on the other hand the wetting of the tungsten carbide grains by the binder is not unnecessarily impaired and precipitates of chromium carbide are avoided.

In one embodiment, the Ru content is from 8-14% by weight of the (Co+Ru) content. In this case, a significant increase in the hot strength is reliably achieved as a result of the relatively high Ru content and, on the other hand, an excessively high Ru content, which would have an adverse effect on the microstructural properties, is also reliably prevented.

In one embodiment the content of Ti, Ta and/or Nb is in each case 0-0.15% by weight. In other words, it is possible, for example, for none of Ti, Ta and Nb to be present in the cemented hard material, but it is also possible for only one of Ti, Ta and Nb, two of Ti, Ta and Nb or all three to be present in an amount up to 0.15% by weight in each case in the cemented hard material. In this way, the properties of the cemented hard material can firstly be additionally influenced by the targeted addition of the elements, and on the other hand this content of Ti, Ta and/or Nb also allows the use of starting materials which already contain Ti, Ta and/or Nb in small amounts, e.g. as a result of a cemented hard material powder recovered in a recycling process.

The total content of (Ti+Ta+Nb) is preferably in the range from 0 to 0.2% by weight of the cemented hard material, more preferably from 0 to 0.15% by weight. In this case, the additional total amounts of Ti, Ta and Nb are kept so small that the positive effects achieved by means of the Ru content and the Cr content and optionally the Mo content are not adversely influenced.

In one preferred embodiment, the cemented hard material has a WC content in the range 80-95% by weight.

In one embodiment, the base material of the cutting machining tool can additionally be provided with a CVD or PVD hard material coating. In this case, the properties of the cutting machining tool can be matched even better to the conditions in the machining of the metal-containing material. However, it should be noted that, depending on the material to be machined, machining without a further hard material coating can also be found to be advantageous.

In one embodiment, the cutting machining tool is configured as a solid cemented hard material tool with a cutting region formed in one piece with a shaft. The combination of high hot strength, high hardness and at the same time relatively high fracture toughness which can be achieved by means of the composition indicated has been found to be particularly advantageous for, in particular, such cutting machining tools.

The object is also achieved by use of a cemented hard material for a cutting machining tool for metal-containing materials as claimed in claim 12. Advantageous embodiments are indicated in the dependent claims.

The cemented hard material has hard material particles embedded in a ductile metallic binder. The metallic binder is a Co—Ru alloy. The hard material particles are at least predominantly formed by tungsten carbide having an average grain size of the tungsten carbide of 0.1-1.2 μm. The cemented hard material has a (Co+Ru) content of 5-17% by weight of the cemented hard material, an Ru content of 6-16% by weight of the (Co+Ru) content, a Cr content of 2-7.5% by weight of the (Co+Ru) content, a content of Ti, Ta and/or Nb of in each case <0.2% by weight of the cemented hard material, preferably in each case <0.15% by weight, and a V content of <0.3% by weight of the cemented hard material, preferably <0.2% by weight. A particularly advantageous combination of high hot strength, fine grain size and high fracture toughness which is particularly suitable for cutting machining of materials which are difficult to machine, in particular high-alloy steels, titanium alloys and superalloys, is achieved by means of the above-described use of the cemented hard material.

In one embodiment, the cemented hard material has an Mo content in the range 0.1-3.0% by weight of the cemented hard material. As starting powder for setting the Mo content, it is possible to use, in particular, Mo₂C powder.

However, addition as metallic molybdenum, for example, is also possible. The addition of molybdenum in the amounts indicated has been found to be particularly advantageous.

Further advantages and useful aspects of the invention can be derived from the following description of working examples with reference to the accompanying figures.

The figures show:

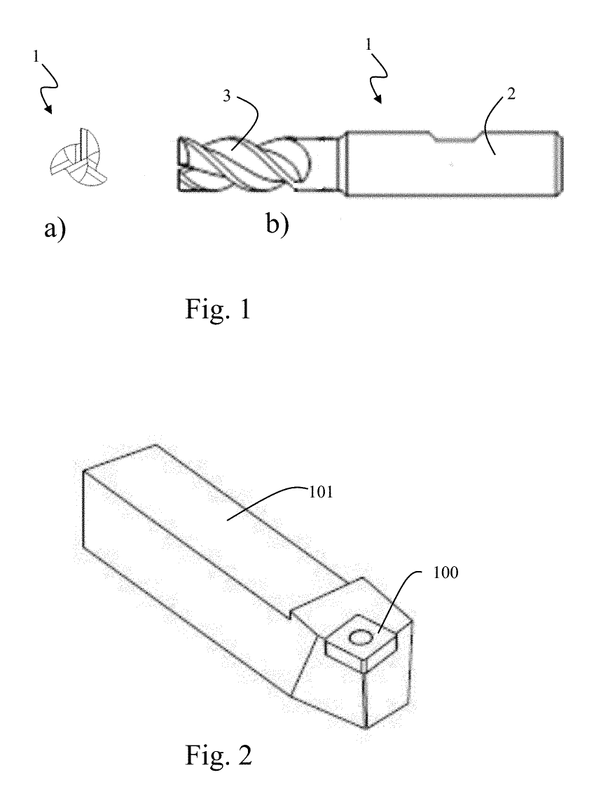

FIGS. 1a) and b) schematic depictions of a cutting machining tool for metal-containing materials according to a first embodiment;

FIG. 2 a schematic depiction of a cutting machining tool for metal-containing materials according to a second embodiment having a tool main element which accommodates the cutting machining tool;

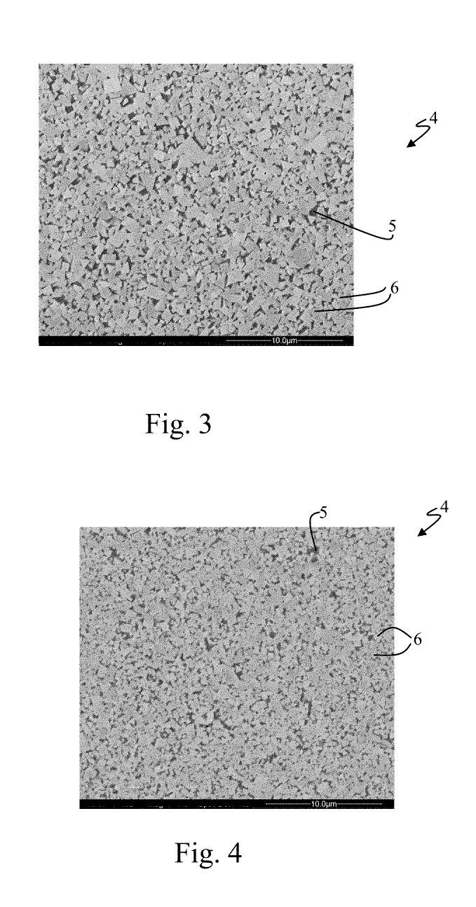

FIG. 3: an electron micrograph at 10 000× enlargement of a base material composed of cemented hard material for a cutting machining tool for metal-containing materials according to a first example of an embodiment;

FIG. 4: an electron micrograph at 10 000× enlargement of a base material composed of cemented hard material for a cutting machining tool for metal-containing materials according to a second example of an embodiment; and

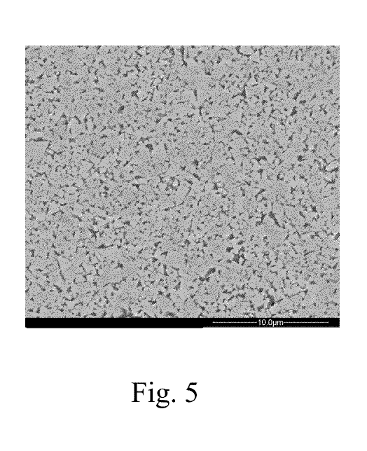

FIG. 5: an electron micrograph at 10 000× enlargement of a cemented hard material according to a comparative example which is not according to the invention.

### EMBODIMENTS

### First Embodiment

A first embodiment of a cutting machining tool 1 for metal-containing materials is shown schematically in FIG. 1a) and FIG. 1b), with FIG. 1a) being a schematic end face view along a longitudinal axis of the cutting machining tool 1 and FIG. 1b) being a schematic side view in a direction perpendicular to the longitudinal axis.

As can be seen in FIG. 1a) and FIG. 1b), the cutting machining tool 1 for metal-containing materials is, according to the first embodiment, configured as a solid cemented hard material tool having a cutting region 3 formed in one piece with a shaft 2. Although the cutting machining tool 1 for metal-containing materials is configured as milling cutter in FIG. 1a) and FIG. 1b), it is also possible, for example, to configure the solid cemented hard material tool for other cutting machining operations, e.g. as drill, reamer, deburrer, etc.

The cutting machining tool 1 has a base material composed of cemented hard material 4 which has hard material particles 6 embedded in a ductile metallic binder 5. The metallic binder 5 is a Co—Ru alloy which comprises cobalt and ruthenium together with other alloying elements, as will be explained below. The hard material particles 6 are at least predominantly formed by tungsten carbide, with the WC grains having an average grain size in the range from 0.1 μm to 1.2 μm. Apart from the WC grains, further hard material particles such as TiC, TaC, NbC, etc., can be present in relatively small amounts. The cemented hard material has a total content of cobalt and ruthenium ((Co+Ru) content) of 5-17% by weight of the cemented hard material, with the Ru content being from 6 to 16% by weight of the (Co+Ru) content. The cemented hard material additionally has a chromium content in the range from 2 to 7.5% by weight of the (Co+Ru) content. A content of Ti, Ta and Nb is in each case less than 0.2% by weight of the cemented hard material and a vanadium content is less than 0.3% by weight, preferably less than 0.2% by weight. The cemented hard material can also preferably comprise molybdenum, with a molybdenum content preferably being in the range 0.1-3.0% by weight of the cemented hard material, preferably in the range 0.15-2.5% by weight of the cemented hard material. The production of the cutting machining tool 1 is carried out in a powder-metallurgical production process as will be described below with reference to specific examples. Although a one-piece configuration made up of a single cemented hard material is present in the embodiment, it is also possible, for example, to make various regions of the cutting machining tool 1 of different cemented hard material types.

### Second Embodiment

A second embodiment of a cutting machining tool 100 for metal-containing materials is depicted schematically in FIG. 2. The cutting machining tool 100 according to the second embodiment is configured as an exchangeable cutting insert which is configured for fastening to a tool main element 101.

Although a cutting insert for turning is depicted schematically as cutting machining tool 100 in FIG. 2, the cutting insert can also be configured for a different type of machining, e.g. for milling, drilling, etc. Although the specific cutting insert depicted is configured for fastening by means of a fastening screw, a configuration for fastening in another way, e.g. for fastening by means of a clamp, a clamping wedge, etc., is also possible.

The cutting machining tool 100 according to the second embodiment also has a base material composed of cemented hard material 4 as has been described with reference to the first embodiment.

### EXAMPLES

The production of the cemented hard materials as base material for a cutting machining tool for metal-containing materials according to the following examples was in each case carried out in a powder-metallurgical production process, with the starting powders, i.e. WC powder, Co powder, Ru powder, Cr₃C₂ powder and optionally Mo₂C powder and/or VC powder in each case being mixed with one another in a first step. In comparative example 1 and comparative example 3, which each do not contain any ruthenium, no Ru powder was used.

As Co powder, use was made of a powder having an average particle size in the range from 0.6 to 1.8 μm, especially having an average particle size of about 0.8 μm (FSSS 1 μm). As Ru powder, use was made of a powder having a relatively large average particle size of about 38.5 μm which was available, but other Ru powders having, for example, particle sizes in the range from <1 μm to 95 μm can readily also be used. Furthermore, Cr₃C₂ powder having an average particle size in the range of about 1-2 μm was used. The WC powder used had an average particle size in the range 0.3-2.5 μm, especially about 0.8 μm, for most examples and comparative examples. The Mo₂C powder used had an average particle size of about 2 μm. A VC powder having an average particle size of about 1 μm was used.

In the experiments, the powder mixture was milled with addition of a milling medium comprising diethyl ether and customary pressing aids (e.g. paraffin wax) for about 3 hours in an attritor mill. The suspension obtained in this way was subsequently spray-dried in a manner known per se in a spray drier.

Rod-shaped green bodies were subsequently produced by dry bag pressing in the experiments. The green bodies produced in this way for tool blanks were subsequently densified at 1430° C. in a sintering-HIP process (HIP=hot isostatic pressing).

From part of the tool blanks made in this way, solid cemented hard material milling cutters as cutting machining tools 1 for metal-containing materials were produced in a manner known per se by grinding, and cutting machining experiments were then carried out using these.

Furthermore, the suspension produced by milling was also spray-dried and the resulting granules were compacted in a die press for green bodies for exchangeable cutting inserts in part of the examples. These green bodies for exchangeable cutting inserts were also subsequently sintered in a corresponding way in order to produce exchangeable cutting inserts as cutting machining tools 100 for metal-containing materials.

Although production involving milling with addition of an organic solvent and subsequent spray drying has been described above, it is also possible, for example, to use water instead of the organic solvent as milling medium, as is known in the technical field of powder-metallurgical production of cemented hard materials. Furthermore, the other shaping methods customary in this field, in particular extrusion or die pressing, can be used instead of the dry bag pressing described. To adjust the carbon balance of the tool blank, small amounts of carbon black or tungsten can be additionally introduced in a manner known per se. Instead of the Cr₃C₂ powder used in the experiments, it is also possible to use, for example, chromium nitride powder, chromium carbonitride powder or the like in corresponding amounts. Instead of the Mo₂C powder used in the experiments, it is also possible to employ metallic Mo powder. Instead of drying the suspension obtained after the milling operation by spray drying in a spray drier, drying in a rotary evaporator and subsequent sieving using a sieve having a mesh opening of 250 μm were used in some examples.

It should be noted that in the above description the content of the constituents of the cemented hard material is partly based on the total cemented hard material and partly only on the (Co+Ru) content. Furthermore, reference is often made to the content of the respective metals Cr, Mo, etc., in the above description. In the following description of production examples (and also in table 1) in which the resulting composition was determined in terms of the proportions of the respective starting materials, on the other hand, the proportions are generally expressed in % by weight of the cemented hard material. The percentages by weight required to make up to 100% are in each case composed of tungsten carbide.

### Example 1

A cemented hard material having the following composition was produced as base material for a cutting machining tool for metal-containing materials.

The cemented hard material of example 1 has a Co content of 10% by weight of the cemented hard material, an Ru content of 1.5% by weight and a Cr content set by addition of 0.6% by weight of Cr₃C₂ powder, balance tungsten carbide (WC). The production of the cemented hard material was carried out in a powder-metallurgical process. This results in: a (Co+Ru) content of 11.5% by weight of the cemented hard material, an Ru content of about 13% by weight of the (Co+Ru) content and a Cr content of about 4.5% by weight of the (Co+Ru) content.

The hardness of the specimen was determined by Vickers hardness measurement (HV30) and the fracture toughness K_{lc} (Shetty) was determined. To check the carbon balance and the resulting grain size, the magnetic coercivity field strength H_{C} and the saturation magnetization 4□□ were determined in a manner known per se. The grain size was also measured as “linear intercept length”, in accordance with the international standard ISO 4499-2:2008(E). EBSD images of polished sections served as basis. The measurement methodology on such images is, for example, described in: K. P. Mingard et al., “Comparison of EBSD and conventional methods of grain size measurement of hard metals”, Int. Journal of Refractory Metals & Hard Materials 27 (2009) 213-223”. The values determined are summarized below in table 2. An electron micrograph of a polished section of the specimen according to example 1 in 10 000× enlargement is shown in FIG. 3.

### Example 2

In a manner analogous to the production of the cemented hard material described in example 1, a cemented hard material having a Co content of 10% by weight, an Ru content of 1.5% by weight, a Cr content set by addition of 0.6% by weight of Cr₃C₂ powder and additionally an Mo content set by addition of 0.6% by weight of Mo₂C, balance tungsten carbide (WC), was produced. This results in: a (Co+Ru) content of 11.5% by weight of the cemented hard material, an Ru content of about 13% by weight of the (Co+Ru) content, a Cr content of about 4.5% by weight of the (Co+Ru) content and an Mo content of about 0.56% by weight of the cemented hard material.

Once again, the measured parameters summarized in table 2 were determined. An electron micrograph at 10 000× enlargement of the specimen according to example 2 is shown in FIG. 4. It can be seen from comparison with example 1 that the additional Mo content has a positive effect on the hardness with essentially the same fracture toughness.

### Comparative Example 1

As comparative example 1, a cemented hard material having a Co content of 11.5% by weight, a Cr content set by addition of 0.6% by weight of Cr₃C₂ powder, balance tungsten carbide (WC), was produced in an analogous way.

For this comparative example 1, too, the measurement parameters shown in table 2 were determined. FIG. 5 shows an electron micrograph at 10 000× enlargement of the specimen according to comparative example 1.

Comparison of the results summarized in table 2 shows that an improved fracture toughness at essentially the same hardness was achieved in the case of the Ru-containing example 1 compared to the Ru-free comparative example 1.

### Example 3

In a manner analogous to the above-described production process, a further cemented hard material was produced by additional addition of VC (vanadium carbide), as follows: 10% by weight of Co, 1.5% by weight of Ru, 0.6% by weight of Cr₃C₂, 0.1% by weight of VC.

The measured values determined can be seen from table 2. It can be seen that in the case of the weakly VC-doped example 3, the hardness determined is somewhat higher, but this is associated with a slightly decreased fracture toughness. The result is thus: a (Co+Ru) content of 11.5% by weight of the cemented hard material, an Ru content of about 13% by weight of the (Co+Ru) content, a Cr content of about 4.5% by weight of the (Co+Ru) content and a V content of about 0.08% by weight of the cemented hard material.

### Comparative Example 2

In an analogous way, a cemented hard material was produced as follows as comparative example 2: 10% by weight of Co, 1.5% by weight of Ru, 0.6% by weight of Cr₃C₂, 0.4% by weight of VC. The result is thus: a (Co+Ru) content of 11.5% by weight of the cemented hard material, an Ru content of about 13% by weight of the (Co+Ru) content, a Cr content of about 4.5% by weight of the (Co+Ru) content and a V content of about 0.32% by weight of the cemented hard material.

As can be seen from table 2, the cemented hard material of this comparative example has a slightly improved hardness but a significantly poorer fracture toughness.

### Example 4

As example 4, a further cemented hard material was produced as base material for a cutting machining tool for metal-containing materials using the following starting materials: 8.7% by weight of Co, 1.3% by weight of Ru, 0.6% by weight of Cr₃C₂, 0.3% by weight of Mo₂C. The result is thus: a (Co+Ru) content of 10% by weight of the cemented hard material, an Ru content of about 13% by weight of the (Co+Ru) content, a Cr content of about 5.2% by weight of the (Co+Ru) content and an Mo content of about 0.28% by weight of the cemented hard material.

As can be seen from the measured values in table 2, a significantly greater hardness is, as expected, achieved at the lower total binder content (Co+Ru), but the decrease in the fracture toughness associated therewith is surprisingly only relatively small.

### Comparative Example 3

As comparative example 3, a ruthenium-free cemented hard material having a Co content of 10% by weight and an amount of Mo and Cr comparable to that in example 4 was also examined. As can be seen from table 4, a significantly greater hardness HV30 was achieved in example 4 than in this comparative example 3.

### Example 5

As example 5, a cemented hard material was produced as base material for a cutting machining tool for metal-containing materials by means of an appropriate production process using the following starting materials: 5.5% by weight of Co, 0.8% by weight of Ru, 0.4% by weight of Cr₃C₂, 0.2% by weight of Mo₂C. The result is thus: a (Co+Ru) content of 6.3% by weight of the cemented hard material, an Ru content of about 13% by weight of the (Co+Ru) content, a Cr content of about 5.5% by weight of the (Co+Ru) content and an Mo content of about 0.19% by weight of the cemented hard material. As can be seen from table 2, a significant increase in the hardness results from the significantly lower total binder content (Co+Ru), with, surprisingly, an only comparatively small decrease in the fracture toughness being observed.

### Example 6

A cemented hard material as base material for a cutting machining tool for metal-containing materials was produced as example 6 from the following starting materials: 13% by weight of Co, 1.9% by weight of Ru, 1.2% by weight of Cr₃C₂, 0.8% by weight of Mo₂C. The result is thus: a (Co+Ru) content of 14.9% by weight of the cemented hard material, an Ru content of about 13% by weight of the (Co+Ru) content, a Cr content of about 7% by weight of the (Co+Ru) content and an Mo content of about 0.75% by weight of the cemented hard material.

### Example 7

In contrast to the above-described examples and comparative examples, in the case of example 7 use was made of a WC powder having an average particle size in the range from 0.1 to 1.2 μm, specifically having an average particle size of about 0.5 μm. The composition was set by means of the following starting materials: 7.1% by weight of Co, 1.1% by weight of Ru, 0.5% by weight of Cr₃C₂ and 0.1% by weight of VC. The result is thus: a (Co+Ru) content of 8.2% by weight of the cemented hard material, an Ru content of about 13.4% by weight of the (Co+Ru) content, a Cr content of about 5.3% by weight of the (Co+Ru) content and a V content of about 0.08% by weight of the cemented hard material.

TABLE 1

| | Co | Ru | Cr₃C₂ | Mo₂C | VC |
|---|---|---|---|---|---|
| | [% by | [% by | [% by | [% by | [% by |
| | weight] | weight] | weight] | weight] | weight] |
| Example 1 | 10 | 1.5 | 0.6 | — | — |
| Example 2 | 10 | 1.5 | 0.6 | 0.6 | — |
| Comparative | 11.5 | — | 0.6 | — | — |
| example 1 | | | | | |
| Example 3 | 10 | 1.5 | 0.6 | — | 0.1 |
| Comparative | 10 | 1.5 | 0.6 | — | 0.4 |
| example 2 | | | | | |
| Example 4 | 8.7 | 1.3 | 0.6 | 0.3 | — |
| Comparative | 10 | — | 0.6 | 0.3 | 0.1 |
| example 3 | | | | | |
| Example 5 | 5.5 | 0.8 | 0.4 | 0.2 | — |
| Example 6 | 13 | 1.9 | 1.2 | 0.8 | — |
| Example 7 | 7.1 | 1.1 | 0.5 | — | 0.1 |

Table 1 summarizes the compositions of the respective examples and comparative examples in percent by weight of the cemented hard material, with the balance to 100% being formed in each case by WC. The following table summarizes the determined measured values for the respective examples and comparative examples.

TABLE 2

| | | | Fracture |
|---|---|---|---|
| | Av. WC grain | | toughness K_{lc} |
| | size [μm] | HV30 | [MPa√m] |
| Example 1 | 0.36 | 1622 | 10.7 |
| Example 2 | 0.31 | 1636 | 10.8 |
| Comparative | 0.42 | 1554 | 10.8 |
| example 1 | | | |
| Example 3 | 0.33 | 1650 | 10.2 |
| Comparative | 0.29 | 1800 | 9.2 |
| example 2 | | | |
| Example 4 | 0.33 | 1697 | 10.4 |
| Comparative | 0.36 | 1600 | 10.4 |
| example 3 | | | |
| Example 5 | 0.34 | 1918 | 9.6 |
| Example 6 | 0.30 | 1536 | 11.4 |
| Example 7 | 0.18 | 1851 | 10.2 |

1-13. (canceled)

14. A cutting machining tool for metal-containing materials, the machining tool comprising:
a base material composed of cemented hard material formed of hard material particles embedded in a ductile metallic binder, said metallic binder being a Co—Ru alloy and said hard material particles being at least predominantly formed by tungsten carbide, and said tungsten carbide having an average grain size of 0.1-1.2 μm;
a (Co+Ru) content of 5-17% by weight of said cemented hard material;
a Ru content of 6-16% by weight of said (Co+Ru) content;
a Cr content of 2-7.5% by weight of said (Co+Ru) content;
a content of one or more elements selected from the group consisting of Ti, Ta and Nb, in each case <0.2% by weight of the cemented hard material; and
a V content of <0.3% by weight of said cemented hard material.

15. The cutting machining tool according to claim 14, wherein said V content amounts to <0.2% by weight of said cemented hard material.

16. The cutting machining tool according to claim 14, wherein said cemented hard material additionally has a Mo content of up to 3.0% by weight of said cemented hard material.

17. The cutting machining tool according to claim 16, wherein said cemented hard material has a Mo content in a range 0.1-3.0% by weight of said cemented hard material.

18. The cutting machining tool according to claim 16, wherein said Mo content is 0.15-2.5% by weight of said cemented hard material.

19. The cutting machining tool according to claim 14, wherein said average grain size of said tungsten carbide is 0.15 μm-0.9 μm.

20. The cutting machining tool according to claim 14, wherein said Cr content is less than said Ru content.

21. The cutting machining tool according to claim 20, wherein said Cr content is less than one half of said Ru content.

22. The cutting machining tool according to claim 14, wherein said Ru content is 8-14% by weight of said (Co+Ru) content.

23. The cutting machining tool according to claim 14, wherein said content of one or more of said Ti, Ta and/or Nb is in each case 0-0.15% by weight.

24. The cutting machining tool according to claim 14, wherein a total content of (Ti+Ta+Nb) is 0-0.2% by weight of said cemented hard material.

25. The cutting machining tool according to claim 24, wherein the total content of (Ti+Ta+Nb) is 0-0.15% by weight of said cemented hard material.

26. The cutting machining tool according to claim 14, wherein said cemented hard material has a WC content in a range of 80-95% by weight.

27. The cutting machining tool according to claim 14, wherein said base material is additionally provided with a CVD or PVD hard material coating.

28. The cutting machining tool according to claim 14, configured as a solid cemented hard material tool having a cutting region formed in one piece with a shaft.

29. A cemented hard material for a cutting machining tool for metal-containing materials, the cemented hard material comprising:
a ductile binder being a Co—Ru alloy and hard material particles embedded in said ductile metallic binder;
said hard material particles being formed at least predominantly by tungsten carbide and said tungsten carbide having an average grain size of 0.1-1.2 μm;
a (Co+Ru) content of 5-17% by weight of the cemented hard material;
a Ru content of 6-16% by weight of said (Co+Ru) content;
a Cr content of 2-7.5% by weight of said (Co+Ru) content;
a content of at least one element selected from the group consisting of Ti, Ta and Nb of in each case <0.2% by weight of the cemented hard material; and
a V content of <0.3% by weight of the cemented hard material.

30. The cemented hard material according to claim 29, wherein the content of any one of said Ti, Ta or Nb is in each case <0.15% by weight, and said V content is <0.2% by weight.

31. The cemented hard material according to claim 29, further comprises a Mo content in a range 0.1-3.0% by weight of the cemented hard material.
